(19) United States
(12) Patent Application Publication
(10) Pub. No.: US 2026/0291387 A1
(43) Pub. Date: Sep. 24, 2026

(54) CHARGE PUMP CONTROL CIRCUIT

(71) Applicant: ABLIC INC., Nagano (JP)

(72) Inventors: Keisuke NAGAO, Nagano (JP); Tsutomu TOMIOKA, Nagano (JP)

(21) Appl. No.: 19/543,600

(22) Filed: Feb. 18, 2026

(30) Foreign Application Priority Data
Mar. 18, 2025 (JP) 2025-043438

(51) Int. Cl. H02M 3/07

(52) U.S. Cl. CPC H02M 3/07

(57) ABSTRACT

Provided is a charge pump control circuit in which current consumption of a charge pump is suppressed. An analog control circuit included in a charge pump control circuit includes a ground terminal, a power supply terminal, an input terminal configured to receive an output voltage of a charge pump, and a control signal output terminal configured to provide a signal for controlling the output voltage of the charge pump in accordance with an input voltage of the input terminal and a breakdown voltage of a Zener diode.

### CROSS-REFERENCE TO RELATED APPLICATIONS

This application claims the priority of Japanese patent application No. 2025-043438, filed on Mar. 18, 2025, the entire contents of which are hereby incorporated herein by reference.

### BACKGROUND OF THE INVENTION

### 1. Field of the Invention

The present invention relates to a charge pump control circuit.

### 2. Description of the Related Art

As a method of generating a reference voltage that has a very small temperature coefficient and is resistant to stress and change over time, the following reference voltage circuit (hereinafter referred to as "buried Zener diode type reference voltage circuit") is used. The buried Zener diode type reference voltage circuit divides a Zener breakdown voltage of a buried Zener diode and a forward voltage of a diode and combines the voltages to cancel out first-order temperature coefficients.

In a buried Zener diode used in this circuit, because a place causing Zener breakdown is a PN junction, the Zener breakdown voltage often becomes 5 V or more. In that case, in order to form the buried Zener diode type reference voltage circuit, a minimum operating power supply voltage of typically 5.3 V or more in total is required as at least the Zener breakdown voltage and a voltage for driving a current source. In a case in which the buried Zener diode type reference voltage circuit is applied to an IC having a power supply voltage that is smaller than about 5.3 V, it is required to devise measures such as boosting the power supply voltage with a charge pump (see also, for example, An Embedded Charge Pump for a Zener-Based Voltage Reference Compensated Using a ΔVBE Stack (The 24th International Conference "Mixed Design of Integrated Circuits and Systems", Jun. 22-24, 2017)).

Generally, a charge pump is able to boost an input voltage, but controls an output voltage by monitoring the output voltage and performing intermittent operation. However, the control method by intermittent operation has a drawback that a large ripple voltage is generated. Accordingly, in a case in which the output voltage of the charge pump is applied to a power supply voltage of a highly accurate reference voltage circuit, it is preferred that a control method using a current source with a small ripple voltage be applied. With this control method, it is possible to control the output voltage of the charge pump to a target voltage by analog-controlling an electric charge supplied to a flying capacitor of the charge pump (see, for example, US Patent No. 6,208,196).

However, an example of problem with charge pumps in general resides in that current consumption is large. In addition to the fact that a load current flows as current consumption after being multiplied by the number of stages of the charge pump, the current consumption further increases due to parasitic capacitance of the charge pump. This current consumption due to the parasitic capacitance increases in proportion to a target value of the output voltage of the charge pump. In the related art as described in US Patent No. 6,208,196 and others, in order to cope with a case in which the minimum operating power supply voltage of the buried Zener diode type reference voltage circuit shifts to a high voltage side due to variations in IC manufacturing, it is required to provide a margin so that the output voltage of the charge pump becomes sufficiently larger than a typical minimum operating power supply voltage of the buried Zener diode type reference voltage circuit. Accordingly, there is room for improvement in that the current consumption due to the parasitic capacitance increases by the amount of the margin.

### SUMMARY OF THE INVENTION

The present invention has an object to provide a charge pump control circuit in which current consumption is suppressed by reducing an excessive margin of a target value of an output voltage of a charge pump by causing the output voltage of the charge pump to change in conjunction with a minimum operating power supply voltage of a reference voltage circuit.

According to at least one embodiment of the present invention, there is provided a charge pump control circuit including:

a ground terminal;

a power supply terminal;

an input terminal configured to receive an output voltage of a charge pump; and

a control signal output terminal configured to provide a signal for controlling the output voltage of the charge pump in accordance with an input voltage of the input terminal and a breakdown voltage of a Zener diode.

According to the at least one embodiment of the present invention, the output voltage of the charge pump changes in conjunction with the minimum operating power supply voltage of the reference voltage circuit, and accordingly an excessive margin of the target value of the output voltage of the charge pump is reduced. Thus, it is possible to provide a charge pump control circuit in which current consumption is suppressed.

### BRIEF DESCRIPTION OF THE DRAWINGS

FIG. 1 is a circuit diagram for illustrating a charge pump control circuit according to a first embodiment of the present invention.

FIG. 2 is a circuit diagram for illustrating a charge pump control circuit according to a second embodiment of the present

invention.

FIG. 3 is a circuit diagram for illustrating a charge pump control circuit according to a third embodiment of the present invention.

### DESCRIPTION OF THE EMBODIMENTS

A charge pump control circuit according to embodiments of the present invention is described below with reference to the drawings. For convenience of description, illustration of a part of the configuration may be omitted or the scale thereof may be changed. In addition, signal names or the like may be described (in parentheses) instead of reference symbols. Further, a "buried Zener diode" may be simply described as a "Zener diode," and a "buried Zener diode type reference voltage circuit" may be simply described as a "reference voltage circuit."

### First Embodiment

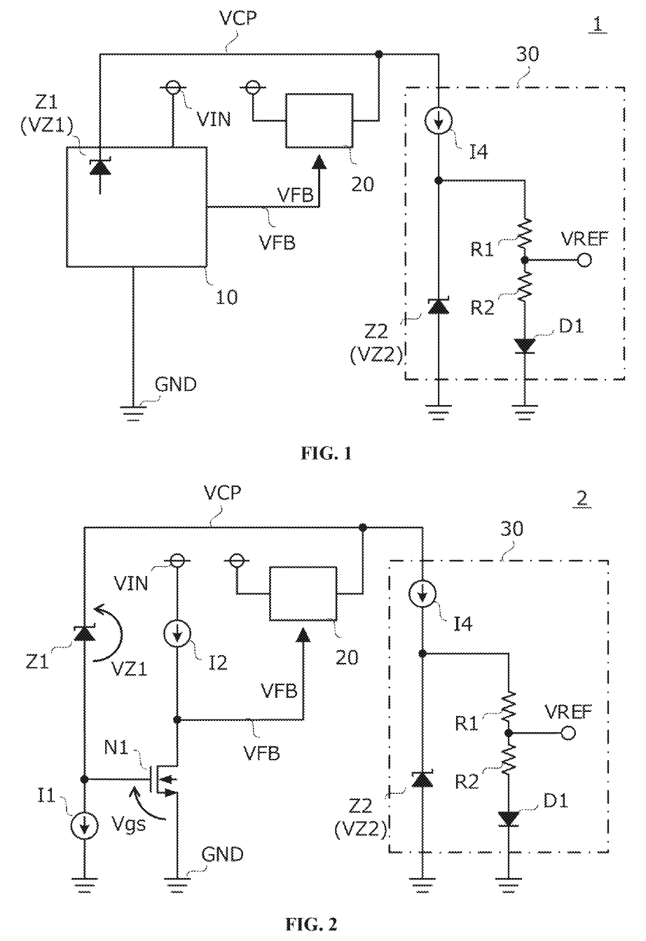

FIG. 1 is a circuit diagram for schematically illustrating a configuration of a charge pump control circuit 1 which is an example of a charge pump control circuit according to a first embodiment of the present invention.

The charge pump control circuit 1 includes a ground terminal GND, a power supply terminal VIN, an analog control circuit 10, a charge pump 20, and a reference voltage circuit 30.

The analog control circuit 10 includes a Zener diode Z1, an input terminal (VCP), and a control signal output terminal (VFB).

The charge pump 20 includes a power supply terminal VIN, a boost output terminal (VCP), and a control signal input terminal (VFB).

The reference voltage circuit 30 includes a ground terminal GND, an input terminal (VCP), a reference voltage output terminal (VREF), a current source I4, a Zener diode Z2, a diode D1, a resistive element R1, and a resistive element R2.

In the analog control circuit 10, the ground terminal GND is grounded, the input terminal (VCP) is connected to the boost output terminal (VCP) of the charge pump 20, and the control signal output terminal (VFB) is connected to the control signal input terminal (VFB) of the charge pump.

In the charge pump 20, the boost output terminal (VCP) is connected to the input terminal (VCP) of the reference voltage circuit 30 and the input terminal (VCP) of the analog control circuit 10.

In the reference voltage circuit 30, the input terminal (VCP) is connected to one end of the current source I4, and the ground terminal GND is connected to an anode of the Zener diode Z2 and a cathode of the diode D1. The resistive element R1 and the resistive element R2 are connected in series between an anode of the diode D1 and a connection point between another end of the current source I4 and a cathode of the Zener diode Z2. A connection point between the resistive element R1 and the resistive element R2 is connected to the reference voltage output terminal (VREF).

The analog control circuit 10 provides a control signal VFB from the control signal output terminal (VFB) in accordance with a boost output voltage VCP of the charge pump 20 received by the input terminal (VCP) and a Zener breakdown voltage VZ1 of the Zener diode Z1.

In a case in which the control signal VFB is received by the control signal input terminal (VFB), the charge pump 20 controls the boost output voltage VCP in accordance with the control signal VFB.

The reference voltage circuit 30 typically requires a power supply voltage of 5.3 V or more in total as a Zener breakdown voltage VZ2 of the Zener diode Z2 and a voltage for driving the current source I4. Because the Zener breakdown voltage VZ1 of the Zener diode Z1 included in the analog control circuit 10 has characteristics equivalent or substantially equivalent to characteristics of the Zener breakdown voltage VZ2 of the Zener diode Z2 included in the reference voltage circuit 30, even in a case in which the Zener breakdown voltage VZ1 of the Zener diode Z1 and the Zener breakdown voltage VZ2 of the Zener diode Z2 vary at the time of manufacturing of the IC, the Zener breakdown voltage VZ1 and the Zener breakdown voltage VZ2 change in conjunction with each other.

The boost output voltage VCP of the charge pump 20 is controlled by the analog control circuit 10 so as to become a voltage (VCP=VZ1+α) exceeding the Zener breakdown voltage VZ1 of the Zener diode Z1. Because VCP is the power supply voltage of the reference voltage circuit 30, it is required to set VCP to a voltage larger than a minimum operating power supply voltage of the reference voltage circuit 30. In this case, because VZ1 and VZ2 change in conjunction with respect to variations at the time of IC manufacturing, a variation in VCP changes in conjunction with a variation in the minimum operating power supply voltage of the reference voltage circuit 30. Accordingly, it is not required to add a margin for coping with variations to a target value of VCP, and it is possible to set VCP to a minimum voltage at which the reference voltage circuit 30 can be operated. That is, it is possible to keep current consumption due to parasitic capacitance of the charge pump low.

As described above, in the charge pump control circuit of the first embodiment, the output voltage of the charge pump changes in conjunction with the minimum operating power supply voltage of the reference voltage circuit, and accordingly an excessive margin of the output voltage of the charge pump is reduced. Thus, it is possible to keep current consumption low.

### Second Embodiment

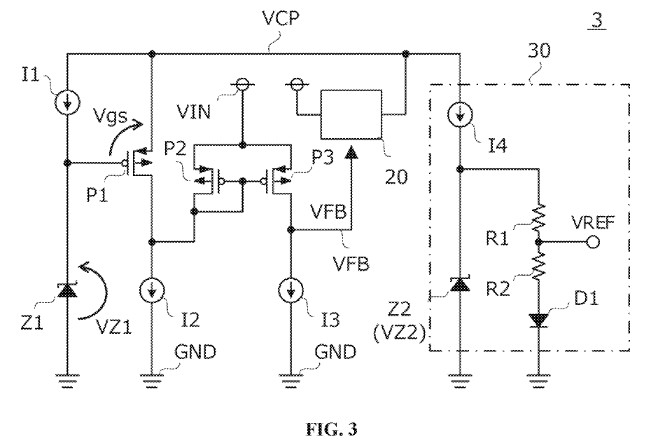

FIG. 2 is a circuit diagram for schematically illustrating a configuration of a charge pump control circuit 2 which is an example of a charge pump control circuit according to a second embodiment of the present invention.

The charge pump control circuit 2 is different from the charge pump control circuit 1 in that the analog control circuit 10 includes current sources I1 and I2 and an NMOS transistor N1 in addition to the Zener diode Z1, but is substantially not different in other points. In view of the above, in the second embodiment, the current sources I1 and I2 and the NMOS transistor N1 are mainly described. In the description of the charge pump control circuit 2, components substantially not different from those of the charge pump control circuit 1 are denoted by the same reference symbols, and description thereof is omitted.

The Zener diode Z1 has a cathode connected to the boost output terminal (VCP) of the charge pump 20 (i.e., connected to a high side). The current source I1 has one end connected to the ground terminal GND. The current source I2 has one end connected to the power supply terminal VIN. The NMOS transistor N1 has a source connected to the ground terminal GND, a gate connected to an anode of the Zener diode Z1 and another end of the current source I1, and a drain connected to another end of the current source I2 and the control signal input terminal (VFB) of the charge pump 20.

The boost output voltage VCP of the charge pump 20 is controlled so as to become a voltage (VCP=VZ1+Vgs) obtained by summing the Zener breakdown voltage VZ1 of the Zener diode Z1 and a gate-source voltage Vgs of the NMOS transistor N1. Because VCP is the power supply voltage of the reference voltage circuit 30, it is required to set VCP to a voltage larger than the minimum operating power supply voltage of the reference voltage circuit 30. In this case, because VZ1 and VZ2 change in conjunction with respect to variations at the time of IC manufacturing, a variation in VCP changes in conjunction with a variation in the minimum operating power supply voltage of the reference voltage circuit 30. Accordingly, it is not required to add a margin for coping with variations to a target value of VCP, and it is possible to set VCP to a minimum voltage at which the reference voltage circuit 30 can be operated. That is, it is possible to keep current consumption due to parasitic capacitance of the charge pump low. Other points are substantially not different from those of the charge pump control circuit 1, and thus description thereof is omitted.

As described above, in the charge pump control circuit of the second embodiment, the output voltage of the charge pump changes in conjunction with the minimum operating power supply voltage of the reference voltage circuit, and accordingly an excessive margin of the output voltage of the charge pump is reduced. Thus, it is possible to keep current consumption low.

### Third Embodiment

FIG. 3 is a circuit diagram for schematically illustrating a configuration of a charge pump control circuit 3 which is an example of a charge pump control circuit according to a third embodiment of the present invention.

The charge pump control circuit 3 is different from the charge pump control circuit 1 in that the analog control circuit 10 includes current sources I1, I2, and I3, a PMOS transistor P1, and a current mirror circuit in addition to the Zener diode Z1, and the current mirror circuit includes a power supply terminal VIN and PMOS transistors P2 and P3, but is substantially not different in other points. In view of the above, in the third embodiment, the current sources I1, I2, and I3, the PMOS transistor P1, the current mirror circuit, and the PMOS transistors P2 and P3 are mainly described. In the description of the charge pump control circuit 3, components substantially not different from those of the charge pump control circuit 1 are denoted by the same reference symbols, and description thereof is omitted.

The Zener diode Z1 has an anode connected to the ground terminal GND (i.e., connected to a low side). The current source I1 has one end connected to the boost output terminal (VCP) of the charge pump 20. The current source I2 has one end connected to the ground terminal GND. The current source I3 has one end connected to the ground terminal GND. The PMOS transistor P1 has a source connected to the boost output terminal (VCP) of the charge pump 20, a gate connected to a cathode of the Zener diode Z1 and another end of the current source I1, and a drain connected to another end of the current source I2 and a mirror source input terminal of the current mirror circuit.

The current mirror circuit includes a pair of PMOS transistors P2 and P3. In the PMOS transistors P2 and P3, respective sources are connected to the power supply terminal VIN, respective gates and a drain of the PMOS transistor P2 are connected to the mirror source input terminal, and a drain of the PMOS transistor P3 is connected to a mirror destination output terminal. The mirror destination output terminal is connected to another end of the current source I3 and the control signal input terminal (VFB) of the charge pump 20.

The boost output voltage VCP of the charge pump 20 is controlled so as to become a voltage (VCP=VZ1+Vgs) obtained by summing the Zener breakdown voltage VZ1 of the Zener diode Z1 and a gate-source voltage Vgs of the PMOS transistor P1. Because VCP is the power supply voltage of the reference voltage circuit 30, it is required to set VCP to a voltage larger than the minimum operating power supply voltage of the reference voltage circuit 30. In this case, because VZ1 and VZ2 change in conjunction with respect to variations at the time of IC manufacturing, a variation in VCP changes in conjunction with a variation in the minimum operating power supply voltage of the reference voltage circuit 30. Thus, it is not required to add a margin for coping with variations to a target value of VCP, and it is possible to set VCP to a minimum voltage at which the reference voltage circuit 30 can be operated. That is, it is possible to keep current consumption due to parasitic capacitance of the charge pump low. Other points are substantially not different from those of the charge pump control circuit 1, and thus description thereof is omitted.

As described above, in the charge pump control circuit of the third embodiment, the output voltage of the charge pump changes in conjunction with the minimum operating power supply voltage of the reference voltage circuit, and accordingly an excessive margin of the output voltage of the charge pump is reduced. Thus, it is possible to keep current consumption low.

The present invention is not limited to the embodiments described above as they are. At the implementation stage, the present invention can be implemented in various forms in addition to the embodiments described above, and various omissions, additions, substitutions, or changes can be made without departing from the gist of the invention. For example, although the PMOS transistors arranged on the high side (power supply terminal side) are used as the pair of transistors forming the current mirror circuit, the present invention is not limited thereto, and NMOS transistors arranged on the low side (ground terminal side) may be used. Further, for example, other components (current source, Zener diode, diode, resistive element, and transistor) may be similarly arranged on the high side or may be arranged on the low side.

The embodiments described above and modifications thereof are encompassed in the scope and the gist of the invention, and are encompassed in the invention defined in the appended claims and equivalents thereof.

What is claimed is:

1. A charge pump control circuit, comprising:
a ground terminal;
a power supply terminal;
an input terminal configured to receive an output voltage of a charge pump; and
a control signal output terminal configured to provide a signal for controlling the output voltage of the charge pump in accordance with an input voltage of the input terminal and a breakdown voltage of a Zener diode.

2. The charge pump control circuit according to claim 1, further comprising:
the Zener diode having a cathode connected to the input terminal;
a first current source having one end connected to the ground terminal;
a second current source having one end connected to the power supply terminal; and
an NMOS transistor having a source connected to the ground terminal, a gate connected to an anode of the Zener diode and another end of the first current source, and a drain connected to another end of the second current source and the control signal output terminal.

3. The charge pump control circuit according to claim 1, further comprising:
the Zener diode having an anode connected to the ground terminal;
a first current source having one end connected to the input terminal;
a second current source having one end connected to the ground terminal;
a third current source having one end connected to the ground terminal;
a first PMOS transistor having a source connected to the input terminal, a gate connected to a cathode of the Zener diode and another end of the first current source, and a drain connected to another end of the second current source; and
a current mirror circuit having a mirror source input terminal connected to the another end of the second current source and the drain of the first PMOS transistor, and a mirror destination output terminal connected to another end of the third current source and the control signal output terminal.

4. The charge pump control circuit according to claim 3, wherein the current mirror circuit includes:
a second PMOS transistor having a source connected to the power supply terminal, a gate connected to the mirror source input terminal, and a drain connected to the mirror source input terminal; and
a third PMOS transistor having a source connected to the power supply terminal, a gate connected to the mirror source input terminal, and a drain connected to the mirror destination output terminal.
